(19) United States
(12) Patent Application Publication
(10) Pub. No.: US 2023/0347456 A1
(43) Pub. Date: Nov. 2, 2023

(54) WELDING JIG AND LASER PROCESSING MACHINE

(71) Applicant: KATAOKA CORPORATION, Kyoto (JP)

(72) Inventors: Katsutoshi NAGASAKI, Kyoto (JP); Keisuke HAYASHI, Kyoto (JP)

(73) Assignee: KATAOKA CORPORATION, Kyoto (JP)

(21) Appl. No.: 17/800,633

(22) PCT Filed: Feb. 19, 2021
(86) PCT No.: PCT/JP2021/006461

§ 371 Date: Aug. 18, 2022

(30) Foreign Application Priority Data
Feb. 19, 2020 (JP) 2020-026347

(51) Int. Cl. B23K 37/04; B23K 26/21; H01M 10/04; H01M 50/566

(52) U.S. Cl. CPC B23K 37/0443; B23K 26/21; H01M 10/0409; H01M 10/049; H01M 50/566; B23K 2101/36

(57) ABSTRACT

A welding jig including a first support member; a second support member; and a pressure adjusting mechanism. Wherein the first support member has a through hole through which a laser beam can pass, the second support member being configured to be insertable into and detachable from a hollow shaft core portion of a jelly roll type electrode assembly, and one end of the second support member supporting an electrode and a bottom of a battery can disposed on a side of one end of the jelly roll type electrode assembly. The pressure adjusting mechanism being configured to adjust a pressure applied between the first support member and the second support member, and the through hole being configured to allow the laser beam to weld the battery can and the electrode.

### CROSS-REFERENCE TO RELATED APPLICATIONS

The present application is based upon and claims the benefit of priority from PCT/JP2021/006461 filed on Feb. 19, 2021, the entire disclosure of which is incorporated herein in its entirety by reference.

### BACKGROUND

### Field

The present disclosure relates to a welding jig and a laser processing machine.

### Art

In production of batteries, as a method for welding a bottomed cylindrical battery can and an electrode (for example, negative electrode) of a jelly roll type (rolling type) electrode assembly with a laser beam, proposed is a method in which a laser beam irradiation nozzle is inserted into a hollow shaft core portion of the jelly roll type electrode assembly, the bottom of the battery can and the electrode are brought into close contact with each other, and the battery can and the electrode are welded by irradiation of the laser beam emitted from the inside of the battery can (Patent Literature 1).

However, in the welding by irradiation of the laser beam emitted from the inside of the battery can, since the insertion and detachment of the laser beam irradiation nozzle must be repeated for each of the battery cans, there is a problem that the tact time becomes long.

As a solution to this problem, it is conceivable to use a welding jig, including: a plate-like support member having a through hole through which a laser beam can pass; and a rod-like support member which is insertable into and detachable from a hollow shaft core portion of a jelly roll type electrode assembly, one end of the rod-like support member being capable of supporting an electrode and a bottom of a battery can disposed on a side of one end of the jelly roll type electrode assembly, wherein an inner surface of the bottom of the battery can and the electrode can be pressure-contacted by applying a pressure between the plate-like support member and the rod-like support member. When this jig is used, since the inner surface of the bottom of the battery can and the electrode are in pressure-contact, the battery can and the electrode can be welded by irradiating the outer surface of the bottom of the battery can corresponding to the contact area between the inner surface of the bottom of the battery can and the electrode with a laser beam.

However, the welding using the jig has a problem that the battery can deforms when applying a pressure between the plate-like support member and the rod-like support member.

### SUMMARY

With the foregoing in mind, it is an object to provide a welding jig capable of welding the battery can and the electrode with a laser beam without deforming the battery can, and a laser processing machine using the welding jig.

In order to achieve the above object, a welding jig is provided, the welding jig including:

a plate-like support member;

a rod-like support member; and

a pressure adjusting mechanism, wherein

the plate-like support member has a through hole through which a laser beam can pass, the rod-like support member is insertable into and detachable from a hollow shaft core portion of a jelly roll type electrode assembly, and one end of the rod-like support member can support an electrode and a bottom of a battery can disposed on a side of one end of the jelly roll type electrode assembly,

the pressure adjusting mechanism can adjust a pressure applied between the plate-like support member and the rod-like support member, and

the welding jig is used for welding the battery can and the electrode with the laser beam.

Also provided is a laser processing machine, including:

a laser oscillator; and

a welding jig as dicussed above, and

a laser beam emitted from the laser oscillator can pass through the through hole of the plate-like support member of the welding jig.

According to such welding jig and laser processing machine, the battery can and the electrode can be welded with a laser beam without deforming the battery can.

### BRIEF DESCRIPTION OF DRAWINGS

FIG. 1 is a schematic cross-sectional view showing an example of the configuration of a welding jig of a first embodiment.

FIG. 2 is a schematic perspective view for explaining a jelly roll type electrode assembly.

FIGS. 3A and 3B are schematic cross-sectional views for explaining a jelly roll type electrode assembly and a battery can. In FIG. 3A is a sectional view in the longitudinal direction and FIG. 3B is a cross-sectional view in the lateral direction.

FIG. 4 is a schematic cross-sectional view showing an example of the configuration of a welding jig of a second embodiment.

FIG. 5 is a schematic cross-sectional view showing an example of the configuration of a welding jig of a third embodiment.

FIG. 6 is a schematic cross-sectional view showing an example of the configuration of a welding jig of a fourth embodiment.

FIGS. 7A-7D are schematic cross-sectional views showing an example of a welding method using the welding jig of the first embodiment.

FIG. 8 is a schematic cross-sectional view showing an example of the configuration of a welding jig of a fifth embodiment.

FIGS. 9A-9D are schematic cross-sectional views showing an example of a welding method using the welding jig of the fifth embodiment.

FIG. 10 is a schematic cross-sectional view showing an example of the configuration of a welding jig of a sixth embodiment.

FIG. 11 is a schematic perspective view showing an example of a galvano scanner in a laser processing machine of a seventh embodiment.

### DETAILED DESCRIPTION

In the present disclosure, the “longitudinal direction” means an axial direction of rolling of the jelly roll type electrode assembly to be described below, and the “lateral direction” means a direction perpendicular to the axis of the rolling.

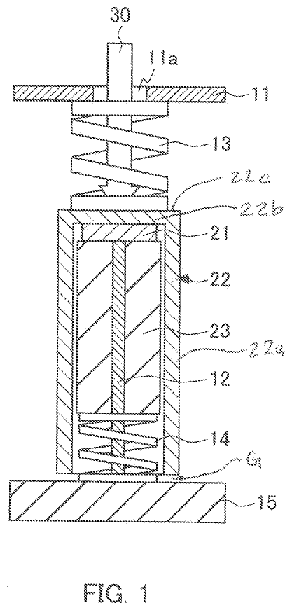

The welding jig and laser processing machine will be described below with reference to the drawings. The present invention, however, is not limited to the following description. Note that there may be cases where the same reference signs are given to the same components in FIGS. 1 to 11 below and descriptions thereof are omitted. Furthermore, for convenience in explanation, the structure of each component shown in FIGS. 1 to 11 may be appropriately simplified, and the size, the ratio, and the like of components may be schematically shown and different from actual ones. In addition, the respective embodiments may be referred to each other in their descriptions unless otherwise specified.

### First Embodiment

FIG. 1 is a schematic cross-sectional view showing an example of the configuration of a welding jig of the present embodiment. The present embodiment shows an example of a welding jig that irradiates the outer surface 22c of the bottom 22b of the battery can 22 with a laser beam 30 from above. As shown in FIG. 1, the welding jig includes a plate-like support member 11, a rod-like support member 12, and a pressure adjusting mechanism 13. The plate-like support member 11 has a through hole 11a through which a laser beam 30 can pass. The rod-like support member 12 is insertable into and detachable from a hollow shaft core portion of a jelly roll type electrode assembly 23, and one end (upper end in FIG. 1) of the rod-like support member can support an electrode 21 and the bottom 22b of a battery can 22 disposed on a side of one end (upper end in FIG. 1) of the jelly roll type electrode assembly 23. While one electrode 21 is used in FIG. 1, a plurality of the electrodes 21 may be stacked. In FIG. 1, the jelly roll type electrode assembly 23, the electrode 21, and the battery can 22 are not the components of the welding jig but a subject to be welded (workpiece), which will be described in detail below. The pressure adjusting mechanism 13 is capable of adjusting a pressure applied between the plate-like support member 11 and the rod-like support member 12. The welding jig may further include, as optional components, a support 14 for preventing the jelly roll type electrode assembly 23 from falling and a support table 15 on which the support 14 is disposed. While a spring is used as the support 14 as an example in FIG. 1, the support 14 may be one other than the spring as long as it can prevent the jelly roll type electrode body 23 from falling.

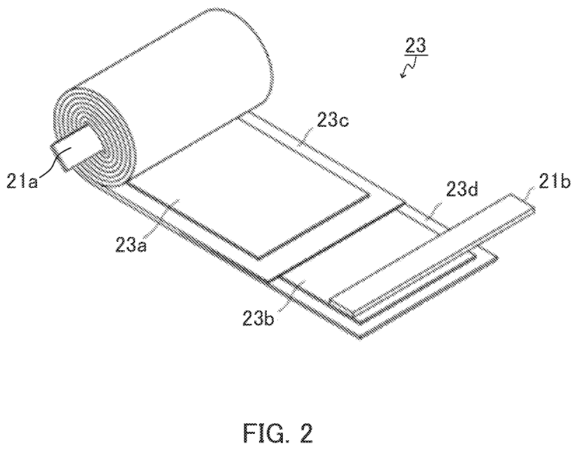

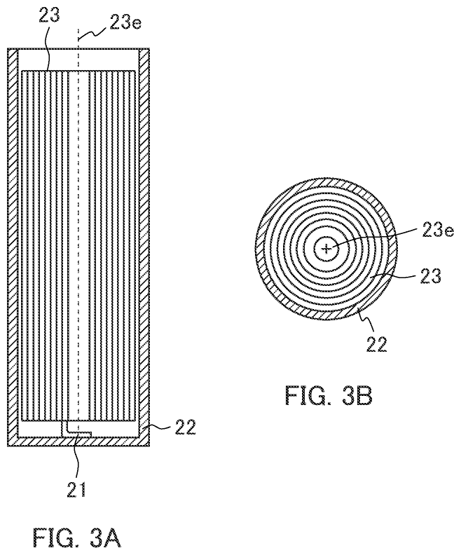

Prior to the description of the components of the welding jig, the jelly roll type electrode assembly 23 and the battery can 22 are described with reference to FIGS. 2 and 3. FIG. 2 is a schematic perspective view for explaining the jelly roll type electrode assembly 23. As shown in FIG. 2, the jelly roll type electrode assembly 23 is consisting of a first electrode sheet 23a (e.g., positive electrode) to which an elongated electrode tab piece 21a is attached, a second electrode sheet 23b (e.g., negative electrode) to which an electrode tab piece 21b is attached, and separators 23d and 23c. The separator 23d, the second electrode sheet 23b, the separator 23c, and the first electrode sheet 23a are stacked in this order and rolled so that the cross-section when cut in the direction perpendicular to the axis of the rolling becomes a circular or elliptical shape. The jelly roll type electrode assembly 23 which has finished rolling is fixed by, for example, a tape or the like, housed in the battery can 22, impregnated with an electrolytic solution of an organic solvent containing an electrolyte, and used as a lithium ion secondary battery or the like. The electrode tab 21b in FIG. 2 corresponds to the electrode 21 shown in FIG. 1, which is a subject to be welded (workpiece). As described above, while one electrode 21 is used in FIG. 1, a plurality of the electrodes 21 may be stacked.

FIG. 3 is a schematic cross-sectional view for explaining the jelly roll type electrode assembly 23 and the battery can 22. FIG. 3A is a cross-sectional view in the longitudinal direction (axial direction of rolling) and FIG. 3B is a cross-sectional view in the lateral direction (direction perpendicular to the axis of rolling). FIG. 3A is an upside-down view of FIG. 1. As shown in FIGS. 3A and 3B, the jelly roll type electrode assembly 23 is housed in the battery can 22, and the shaft core portion 23e of the jelly roll type electrode assembly 23 is hollow. While the cross-section of the lateral direction of the jelly roll type electrode assembly 23 and the battery can 22 (direction perpendicular to the axis of rolling) is a circular shape in FIGS. 2 and 3, as long as the shaft core portion of the jelly roll type electrode assembly 23 is hollow, the shape of the cross-section may be a square shape, a rectangular shape, or the like.

In the present embodiment, the plate-like support member 11 is disposed above the bottom 22b of the battery can 22 in such a manner that the through hole 11a of the plate-like support member 11 is positioned above the hollow shaft core portion of the jelly roll type electrode assembly 23. The plate-like support member 11 may have the through hole 11a through which the laser beam 30 can pass, and its material, thickness, and the like are not particularly limited, and its planar shape may be any shape such as a circular shape, a rectangular shape, and the like, however, the cross-sectional area in the lateral direction of the plate-like support member 11 can be larger than the cross-sectional area in the lateral direction of the bottom 22b of the battery can 22. While one plate-like support member 11 is used in FIG. 1, a plurality of such as three or four plate-like support members 11 may be used. The shape and the like of the through hole 11a will be described below.

The cross-sectional area in the lateral direction of the rod-like support member 12 is slightly smaller than the cross-sectional area in the lateral direction of the hollow shaft core portion of the jelly roll type electrode assembly 23. In the present embodiment, the length of the rod-like support member 12 is substantially the same as the sum of the length of the hollow shaft core portion of the jelly roll type electrode assembly 23 and the height of the support 14. As the rod-like support member 12, for example, a ceramic rod or the like can be used.

From the viewpoint of preventing the heat generated during welding from affecting the jelly roll type electrode assembly 23, the shape and size of the cross-section in the lateral direction of the through hole 11a of the plate-like support member 11 can be substantially the same as the shape and size of the cross-section in the lateral direction of the rod-like support member 12 and the hollow shaft core portion of the jelly roll type electrode assembly 23. At this time, for example, if the cross-sectional shapes of them are circular, the diameter of the through hole 11a of the plate-like support member 11 may have substantially the same size as the diameter of the rod-like support member 12 and the hollow shaft core portion of the jelly roll type electrode assembly 23.

The configuration of the pressure adjusting mechanism 13 is not particularly limited as long as the pressure applied between the plate-like support member 11 and the rod-like support member 12 can be adjusted. In the present embodiment, as shown in FIG. 1, the pressure adjusting mechanism 13 is disposed between the plate-like supporting member 11 and the bottom 22b of the battery can 22. While a spring is used as the pressure adjusting mechanism 13 in FIG. 1, the pressure adjusting mechanism 13 may be an elastic body other than a spring.

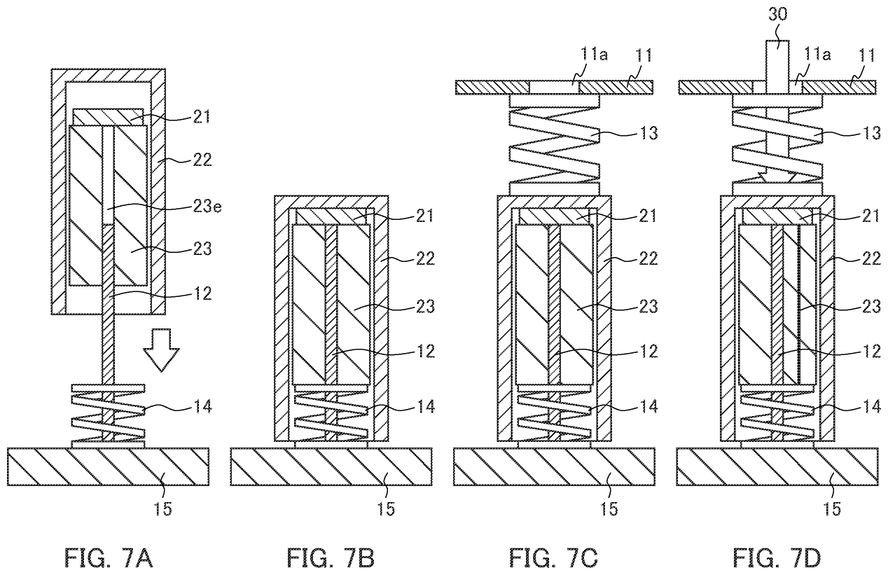

Next, an example of a welding method using the welding jig of the present embodiment will be described with reference to FIGS. 7A-7D. First, as shown in FIG. 7A, the battery can 22 is housed in the jelly roll type electrode assembly 23, and the rod-like support member 12 is inserted into the hollow shaft core portion 23e of the jelly roll type electrode assembly 23. Next, as shown in FIG. 7B, the inner surface of the bottom 22b of the battery can 22 and the electrode 21 are brought into contact by one end (upper end in FIG. 7B) of the rod-like support member 12. Next, as shown in FIG. 7C, the bottom 22b of the battery can 22 is pressed from above by the plate-like support member 11 and the pressure adjusting mechanism 13. At this time, the inner surface of the bottom 22b of the battery can 22 and the electrode 21 are brought into close contact by the pressure adjusting mechanism 13 at a pressure that does not cause deformation of the battery can 22. However, due to maintaining a gap G between the support table 15 and the walls 22a of the can 22, an appropriate compressive force is applied to the bottom 22b of the battery can 22 from the pressure adjusting mechanism 13.

Next, as shown in FIG. 7D, the battery can 22 and the electrode 21 are welded by emitting a laser beam 30 from the through hole 11a of the plate-like support member 11. In the example shown in FIG. 7D, the laser beam 30 passing through the through hole 11a of the plate-like support member 11 is emitted from the gap of the spring, which is the pressure adjusting mechanism 13, to the outer surface 22c of the bottom 22b of the battery can 22. When an elastic body other than a spring is used as the pressure-adjusting mechanism 13, the outer surface 22c of the bottom 22b of the battery can 22 may be irradiated with the laser beam 30 by providing a through hole through which the laser beam 30 can pass in the elastic body.

According to the present embodiment, the battery can 22 and the electrode 21 can be welded with the laser beam 30 without deforming the battery can 22 by adjusting the pressure applied between the plate-like support member 11 and the rod-like support member 12 using the pressure adjusting mechanism 13. Further, according to the present embodiment, unlike a conventional welding by the irradiation of a laser beam from the inside of the battery can using an irradiation nozzle inserted into the hollow shaft core portion of the jelly roll type electrode assembly, the battery can 22 and the electrode 21 can be welded by irradiating the outer surface 22c of the bottom 22b of the battery can 22 corresponding to the contact region between the inner surface of the bottom 22b of the battery can 22 and the electrode 21 with the laser beam 30. Therefore, the present embodiment allows the welding of any shape.

### Second Embodiment

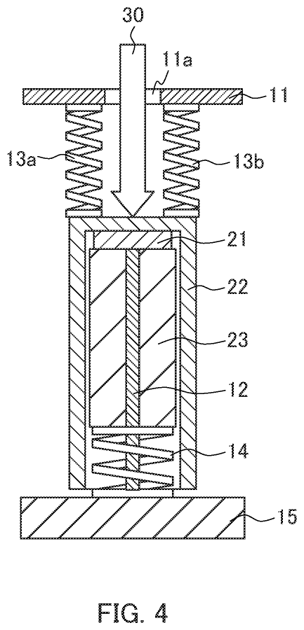

FIG. 4 is a schematic cross-sectional view showing an example of the configuration of a welding jig of the present embodiment. As shown in FIG. 4, the welding jig of the present embodiment is the same as the welding jig of the first embodiment except that it includes two pressure adjusting mechanism 13 springs (spring 13a and spring 13b). While the welding jig includes two pressure adjusting mechanism 13 springs in FIG. 4, the welding jig may include three or more pressure adjusting mechanism 13 springs. If the welding jig includes a plurality of the pressure adjusting mechanism 13 springs, it is easy to maintain the battery can 22 laterally.

### Third Embodiment

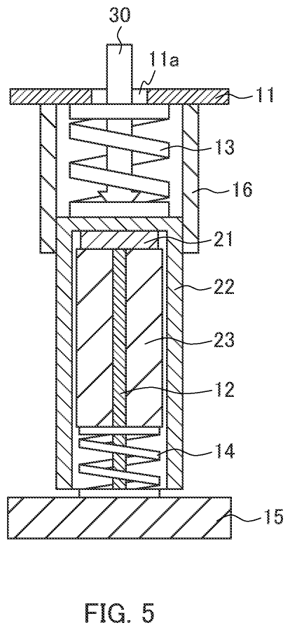

FIG. 5 is a schematic cross-sectional view showing an example of the configuration of a welding jig of the present embodiment. As shown in FIG. 5, the welding jig of the present embodiment is the same as the welding jig of the first embodiment except that it further includes a battery can guide 16 and the position of the battery can 22 can be adjusted by the battery can guide 16. The battery can guide 16 may have a cylindrical shape or the like protruded from the plate-like support member 11 and surrounding the upper portion of the battery can 22 as shown in FIG. 5, for example. Provision of the battery can guide 16 prevents the battery can 22 from tilting when a pressure is applied between the plate-like support member 11 and the rod-like support member 12.

### Fourth Embodiment

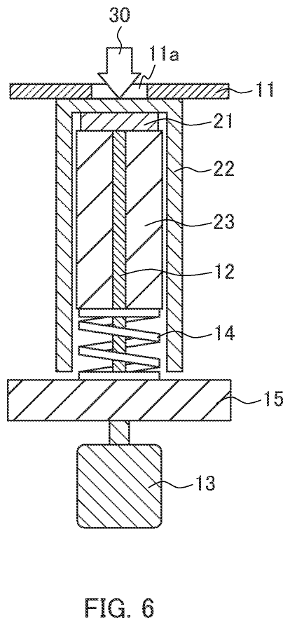

FIG. 6 is a schematic cross-sectional view showing an example of the configuration of a welding jig of the present embodiment. As shown in FIG. 6, in the welding jig of the present embodiment, the pressure adjusting mechanism 13 is disposed on the side of the other end (lower end in FIG. 6) of the rod-like support member 12 through the support table 15 instead of between the plate-like support member 11 and the battery can 22. In the present embodiment, as the pressure adjusting mechanism 13, for example, a motor, an air cylinder, or the like capable of pressing the other end of the rod-like support member 12 may be used. Except for these, the welding jig of the present embodiment is the same as the welding jig of the first embodiment shown in FIG. 1.

### Fifth Embodiment

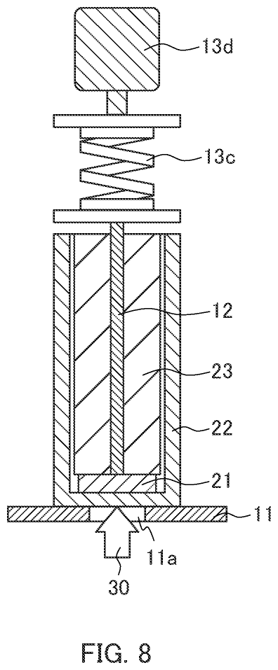

FIG. 8 is a schematic cross-sectional view showing an example of the configuration of a welding jig of the present embodiment. The present embodiment shows an example of a welding jig for irradiating the outer surface 22c of the bottom 22b of the battery can 22 with the laser beam 30 from below. As shown in FIG. 8, in the present embodiment, the positional relationship of the plate-like support member 11, the battery can 22, the electrode 21, the jelly roll type electrode assembly 23, and the rod-like support member 12 inserted into the hollow shaft core portion of the jelly roll type electrode assembly 23 is upside down of that of the fourth embodiment shown in FIG. 6. The length of the rod-like support member 12 is slightly longer than the length of the hollow shaft core portion of the jelly roll type electrode assembly 23. The pressure adjusting mechanisms 13c and 13d are disposed on the side of the other end (upper end in FIG. 8) of the rod-like support member 12. The pressure adjusting mechanism 13c is the same as the pressure adjusting mechanism 13 of the first embodiment shown in FIG. 1. The pressure adjusting mechanism 13d is the same as the pressure adjusting mechanism 13 of the fourth embodiment shown in FIG. 6. The welding jig of the present embodiment may include both of the pressure adjusting mechanisms 13c and 13d as shown in FIG. 8, or may include only one of them.

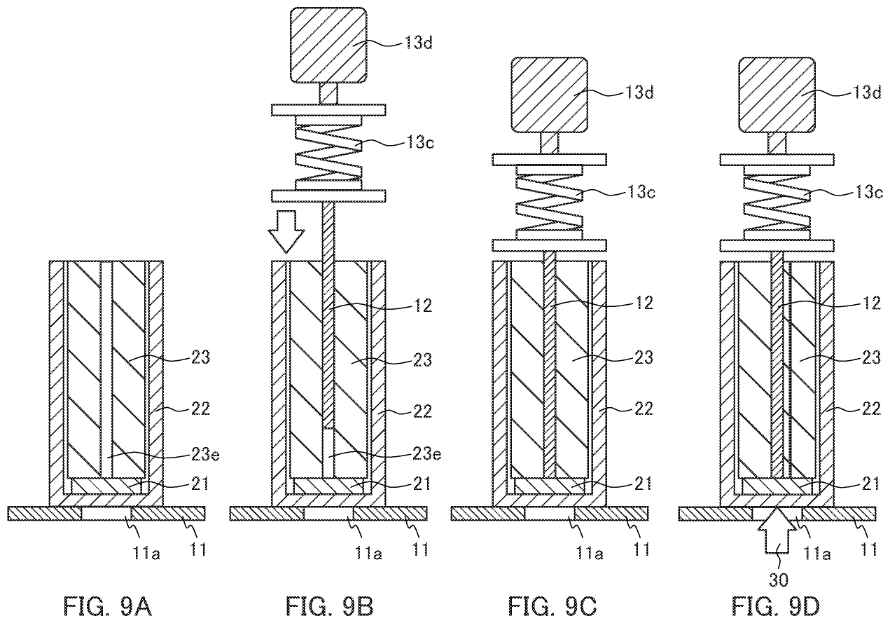

Next, an example of a welding method using the welding jig of the present embodiment will be described with reference to FIGS. 9A-9D. First, as shown in FIG. 9A, the battery can 22 and the jelly roll type electrode assembly 23 are disposed on the plate-like support member 11. Next, as shown in FIG. 9B, the rod-like support member 12 is inserted into the hollow shaft core portion 23e of the jelly roll type electrode assembly 23. Next, as shown in FIG. 9C, the rod-like support member 12 is pressed down by the pressure adjusting mechanisms 13c and 13d so as to bring the electrode 21 into contact with one end (lower end in FIG. 9C) of the rod-like support member 12. At this time, the inner surface of the bottom 22b of the battery can 22 and the electrode 21 are brought into close contact by the pressure adjusting mechanisms 13c and 13d at a pressure that does not cause deformation of the battery can 22. Next, as shown in FIG. 9D, the battery can 22 and the electrode 21 are welded by emitting the laser beam 30 from the through hole 11a of the plate-like support member 11.

### Sixth Embodiment 6

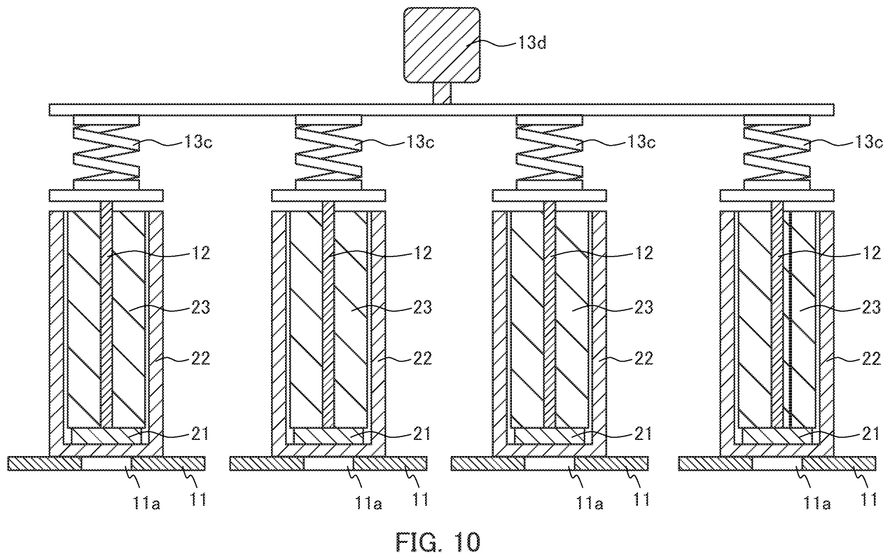

FIG. 10 is a schematic cross-sectional view showing an example of the configuration of a welding jig of the present embodiment. As shown in FIG. 10, the welding jig of the present embodiment is the same as the welding jig of the fifth embodiment shown in FIG. 8 except that four welding jigs are connected through a pressure adjusting mechanism 13c. While four welding jigs are used in FIG. 10, the number of welding jigs can be increased or decreased as necessary. According to the welding jig of the present embodiment, since a plurality of electrodes 21 and the bottoms 22b of the battery cans 22 can be supported and welded at once, the welding jigs can be mass-produced.

### Seventh Embodiment

The present embodiment shows an exemplary laser processing machine. The laser processing machine of the present embodiment includes a laser oscillator and the welding jig of the above embodiments, wherein a laser beam emitted from the laser oscillator can pass through the through hole 11a of the plate-like support member 11 of the welding jig. As the laser oscillator, for example, a commercially available product for welding the battery can and the electrode can be used.

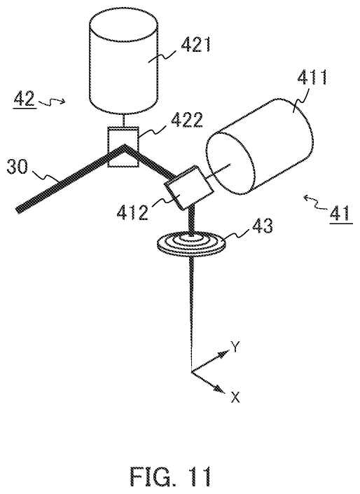

When the laser processing machine of the present embodiment includes the welding jig of the sixth embodiment shown in FIG. 10, which is capable of supporting the plurality of electrodes 21 and the bottoms 22b of the battery cans 22 at once, the laser processing machine may further include a galvano scanner. FIG. 11 is a schematic perspective view showing an example of the galvano scanner. The galvano scanners 41 and 42 can change the optical axis of the laser beam 30 by rotating mirrors 412 and 422 reflecting the laser beam 30 with motors 411 and 421 (e.g., servo motors, stepping motors, etc.). In the example shown in FIG. 11, the X-axis galvano scanner 41 for changing the optical axis of the laser beam 30 in the X-axis direction and the Y-axis galvano scanner 42 for changing the optical axis of the laser beam 30 in the Y-axis direction are provided, and the irradiation position of the laser beam 30 can be controlled in the XY two-dimensional direction. In FIG. 11, the reference sign 43 indicates a condenser lens (e.g., FO lens, etc.). As the galvano scanner, a self-produced product or a commercially available product may be used. With the galvano scanner, for example, the laser beam emitted from the laser oscillator can be guided so as to sequentially pass through the through holes 11a of the four plate-like support members 11 in the welding jig of the sixth embodiment shown in FIG. 10. As a result, according to the laser processing machine of the present embodiment, the tact time can be shorter than the conventional welding in which the laser beam irradiation nozzle is repeatedly inserted into and detached from each of the battery cans.

As described above, the battery can and the electrode can be welded with a laser beam without deforming the battery can. Therefore, the welding jig and laser processing machine disclose above can be extremely useful in production of various batteries, such as lithium ion secondary batteries.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A welding jig comprising:
a first support member;
a second support member; and
a pressure adjusting mechanism,
wherein the first support member has a through hole through which a laser beam can pass, the second support member being configured to be insertable into and detachable from a hollow shaft core portion of a jelly roll type electrode assembly, and one end of the second support member supporting an electrode and a bottom of a battery can disposed on a side of one end of the jelly roll type electrode assembly,
the pressure adjusting mechanism being configured to adjust a pressure applied between the first support member and the second support member, and
the through hole being configured such that the laser beam passes through the through hole to weld the battery can and the electrode.

2. The welding jig according to claim 1, wherein the pressure adjusting mechanism is an elastic body.

3. The welding jig according to claim 1, wherein the pressure adjusting mechanism is one of disposed between the first support member and the bottom of the battery can or disposed on a side of an other end of the second support member.

4. The welding jig according to claim 2, wherein the elastic body is a spring.

5. The welding jig according to claim 4, wherein the spring comprising a plurality of springs.

6. The welding jig according to claim 1, wherein the pressure adjusting mechanism is at least one of a motor or an air cylinder that can press an other end of the second support member.

7. The welding jig according to claim 1, wherein the second support member is a ceramic rod.

8. The welding jig according to claim 1, wherein:
the first support member comprises one or more first support members having a plurality of through holes through which the laser beam can pass, the plurality of through holes corresponding to a plurality of electrodes and a plurality of battery cans;
the second support member comprises a plurality of second support members, each of the plurality of second support members being configured to be insertable into and detachable from the hollow shaft core portion of the jelly roll type electrode assembly corresponding to each of the plurality of battery cans, and one end of each of the plurality of second support members supporting a corresponding electrode and corresponding bottom of the battery can disposed on the side of one end of the corresponding jelly roll type electrode assembly; and
the pressure adjusting mechanism comprises one or more pressure adjusting mechanisms, configured to adjust a pressure applied between each first support member and each second support member, and
each through hole being configured to allow the laser beam to weld a corresponding battery can and electrode.

9. The welding jig according to claim 1, wherein a diameter of the through hole of the first support member and a diameter of the hollow shaft core portion of the jelly roll type electrode assembly are substantially a same size.

10. The welding jig according to claim 1, further comprising:
a battery can guide,
wherein a position of the battery is adjustable by the battery can guide.

11. A laser processing machine, comprising:
a laser oscillator; and
the welding jig according to claim 1,
wherein a laser beam emitted from the laser oscillator is configured to pass through the through hole of the first support member.

12. The laser processing machine according to claim 11, further comprising:
a galvano scanner,
wherein the laser beam emitted from the laser oscillator is configured to pass through the through hole of the first support member by the galvano scanner.

13. The welding jig according to claim 1, wherein the first support member comprises a plate.

14. The welding jig according to claim 1, wherein the second support member comprises a rod.
